(19) United States
(12) Patent Application Publication
(10) Pub. No.: US 2009/0200865 A1
(43) Pub. Date: Aug. 13, 2009

(54) DEVICE FOR GENERATING ELECTRICAL ENERGY IN A MOTOR VEHICLE AND A MOTOR VEHICLE WITH SUCH A DEVICE

(75) Inventors: Thomas Grossner, Neutraubling (DE); Christoph Klesse, Wörth A.D. Donau (DE); Christian Taudt, Regensburg (DE); Lorand de Ouvenou, Bernhardswald (DE)

Correspondence Address: King & Spalding LLP, 401 Congress Avenue, Suite 3200, Austin, TX, 78701, US

(73) Assignee: CONTINENTIAL AUTOMOTIVE GMBH, Hannover (DE)

(21) Appl. No.: 12/304,762

(22) PCT Filed: Aug. 31, 2007
(86) PCT No.: PCT/EP2007/059131

§ 371 Date: Dec. 13, 2008

(30) Foreign Application Priority Data
Sep. 19, 2006 (DE) 10 2006 044 004.8

(51) Int. Cl. B60L 1/00

(52) U.S. Cl. 307/10.1

(57) ABSTRACT

In a device for generating electrical energy in a motor vehicle and a motor vehicle with such a device, a microturbine 30; 60; 80 is connected to energy-conducting systems of the motor vehicle 1, for example the high-pressure injection system 20, the hydraulic system 70 or the compressed air system 50, in order to utilize the energy which is to be output to the surroundings and to convert it into electrical energy.

### CROSS-REFERENCE TO RELATED APPLICATIONS

This application is a U.S. National Stage Application of International Application No. PCT/EP2007/059131 filed Aug. 31, 2007, which designates the United States of America, and claims priority to German Application No. 10 2006 044 004.8 filed Sep. 19, 2006, the contents of which are hereby incorporated by reference in their entirety.

### TECHNICAL FIELD

The present invention relates to a method for generating electrical energy in a motor vehicle.

### BACKGROUND

Modern motor vehicles are equipped with one or a plurality of subsystems, which ensure the operation of the motor vehicle, store energy and also transfer energy to other devices in the motor vehicle. A common rail injection system, which ensures the fuel injection in an internal combustion engine, a pressurized air system, which ensures the supply of a brake of the motor vehicle and other devices and a hydraulic system, with which lifting devices of a motor vehicle can be moved for instance, form part of these subsystems. The above systems release frequently stored energy to their environment, for instance in the form of heat or by a pressure drop at the throttle points, in order to prevent the respective system from overloading and being damaged.

This energy transfer or the system-specific power loss is described below in the example of the common rail system. These power losses are caused above all by the decompression of the highly pressurized fuel. They appear at all throttle points in the common rail system. Switching and continuous leakages on the injectors of the common rail system thus causes throttle losses. Additional throttle losses occur on the pressure control valve PCV. The common rail system also has a return line to the fuel tank, by way of which compressed fuel is fed out of the common rail system into the tank. With a system pressure of 2000 bar, the energy fed into the return line to the tank can amount to up to 4 kW despite a closed control loop with a volume control valve VCV as well as injectors loaded with switching and continuous leakages.

The decompression of the fuel in the return line in the case of an ambient temperature releases the heat, as a result of which high fuel temperatures are reached. The fuel at the throttle point in the common rail system is heated to approximately 40 to 50 K per 1000 bar of pressure drop to the ambient pressure level. For a system pressure in the common rail system of 2000 bar and a maximum fuel supply temperature of 80° C., this means a fuel temperature of 160° C. to 180° C. at the throttle point in the return line. The fuel properties begin to change from approximately 135° C., particularly in the case of US diesel fuels, and can contribute to additional wear in the case of components conveying the fuel.

To minimize the afore-described input of energy into the fuel or general throttle losses, attempts are made to achieve a pump conveyance which is tailored to suit a market need in the case of modern common rail systems. This can be realized with the aid of a VCV closed control loop for the rail pressure. On the other hand, leakage-reduced to leakage-free injectors are used. Furthermore, attempts are also made with aid of additional coolers to hold the fuel within a permissible temperature range.

As was described above in the example of the common rail system, attempts were previously made to minimize the occurring loss of power by adjusting the respective system. As this is only possible to limited degree, a relatively large amount of energy is still always output to the environment, which can thus no longer be used in the motor vehicle.

### SUMMARY

According to various embodiments, a device can be provided, with which occurring losses of power can be used in the motor vehicle.

According to an embodiment, a device for generating electrical energy in a motor vehicle, may comprise: at least one microturbine with a controller, wherein the at least one microturbine can be connected to an energy-conveying system, preferably to a high pressure injection system and/or a hydraulic system and/or a pressurized air system of the motor vehicle, such that the at least one microturbine can be powered by the energy-conveying system, preferably the high pressure injection system and/or the hydraulic system and/or the pressurized air system, in order to provide electrical energy for systems of the motor vehicle.

According to a further embodiment, the device may have an accumulator, in which the electrical energy generated by the microturbines can be stored. According to a further embodiment, the controller of the device with which the microturbine can be switched on and off, so that the energy which can be discharged for a reduction in the energy-conveying system, in particular of the high pressure injection system and/or of the hydraulic system and/or the pressurized air system can be used by the microturbine and/or the energy-conveying system, in particular the high pressure injection system and/or the hydraulic system and/or the pressurized air system, can be reduced by switching the microturbine off.

According to another embodiment, a motor vehicle may comprise at least one microturbine, with which electrical energy can be generated, an energy-conveying system, with which energy can be transmitted to other components of the motor vehicle and can be connected to the microturbine so that the microturbine can be powered by the subsystem, and an accumulator, in which the electrical energy generated by the microturbine can be stored.

According to a further embodiment, the motor vehicle may not include a generator. According to a further embodiment, the at least one microturbine of the motor vehicle may be powered by fuel. According to a further embodiment, the energy-conveying system of the motor vehicle can be a high pressure injection system and/or a hydraulic system and/or a pressurized air system of the motor vehicle. According to a further embodiment, the at least one microturbine of the motor vehicle can be coupled to the high pressure injection system and/or the hydraulic system and/or the pressurized air system such that energy discharged in order to relieve the system can be converted into electrical energy by the microturbine.

### BRIEF DESCRIPTION OF THE DRAWINGS

Preferred embodiments are described in more detail with reference to the appended drawing, in which;

FIG. 1 shows a block diagram of a device according to an embodiment.

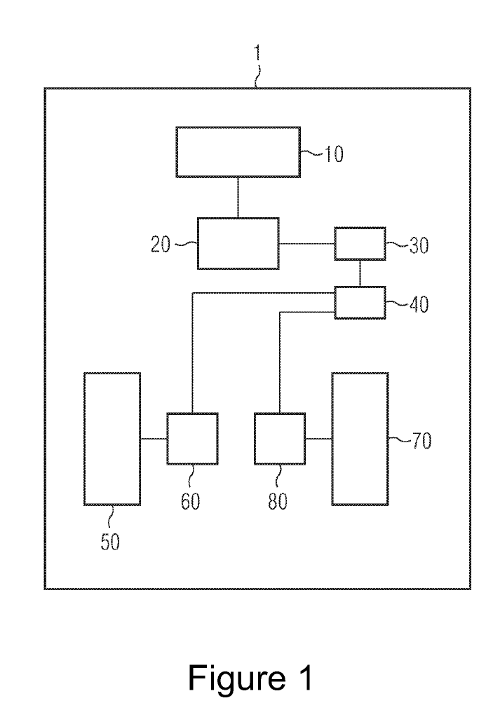

### DETAILED DESCRIPTION

The afore-described device according to various embodiments includes at least one microturbine with a controller, while the at least one microturbine can be connected to an energy-conveying system, preferably a high-pressure injection system and/or a hydraulics system and/or a pressurized air system of the motor vehicle such that the at least one microturbine can be powered by means of an energy-conveying system, in order to provide electrical energy for systems of the motor vehicle.

In order to be able to better use the stored energy from the energy-saving and/or energy-conveying systems in the motor vehicle in comparison to the prior art, and in order not to have to emit losses of power of this system into the environment, the various embodiments may use at least one microturbine. These microturbines are for instance generators miniaturized to chip sizes, which convert the energy of a flowing liquid into a rotational movement and then into electrical energy. The concept of the microturbines is described in the article “Die Liliput-Maschinen” [The Liliput machine] (Technology Review, December 2004, page 58 to 61). It is possible based on the miniaturization of known turbine and generator technologies to integrate a microturbine in existing energy-saving and energy-forwarding systems of motor vehicles. These energy-saving and energy-forwarding systems include a common rail injection system, a pressurized air system, a hydraulic system, a cooling system or an exhaust gas system, to name a few examples from the automotive field. All these systems have throttle points, overload valves and/or regions with a rapidly flowing medium, at which losses of power occur or system energy can be used for powering a microturbine. The throttle points are characterized in that relatively high flow speeds of the respective medium in the system occur here, which can then be converted into electrical energy with the aid of at least one microturbine.

In the case of an inadequate performance of one or a plurality of microturbines, one embodiment consists in replacing the known generator with one or a plurality of microturbines. It is also preferred to forward the electrical energy generated by the at least one microturbine to an accumulator and to store it there.

According to a further embodiment, the at least one microturbine can be switched on and/or off by way of a controller so that it results in the high pressure injection system and/or the hydraulic system and/or the pressurized air system reducing, with the dischargeable energy being useable by the at least one switched-on microturbine. Or however, the high pressure injection system and/or the hydraulic system and/or the pressurized air system can be relieved by switching off the microturbine.

Furthermore, according to another embodiment a motor vehicle may have the following features: at least one microturbine with which electrical energy can be generated, a subsystem with which energy can be transmitted to other components of the motor vehicle and with which the microturbine can be connected so that the microturbine can be powered by the subsystem and an accumulator, in which the electrical energy generated by the microturbine can be stored.

The various embodiments are used to generate electrical energy in the motor vehicle 1 with the aid of at least one microturbine 30, 60, 80. Microturbines 30, 60, 80 operate according to the known generator principle, the gas turbine principle or similarly known combustion engines. These microturbines 30, 60, 80 have approximately the size of a microchip, so that their dimensions range within millimeters. As a result of the minimal geometric dimensions, they can be integrated with minimal effort into already existing systems, for instance in a motor vehicle. These systems use energy or lost energy of the systems in order to convert this into electrical energy. It is likewise conceivable that the microturbines themselves generate energy by burning fuel.

The microturbines 30, 60, 70 can be integrated into all energy-conveying or energy-storing systems. In the motor vehicle 1, these are common rail injection systems 20 for instance, a pressurized air system 50, a hydraulic system 70, a cooling system, an exhaust gas system and other. These systems 20, 50, 70 store and/or guide energy in the form of a compressed and/or rapidly flowing medium for instance or in the form of heat. This compressed medium, for instance air, fuel or hydraulics liquid, is temporarily decompressed in order to protect the system 20, 50, 70 from overloading. This decompression of the medium, which can also occur for other reasons, allows energy to be output to the environment unused. This loss of power in the systems 20, 50, 70 is used based on different embodiments to drive at least one microturbine 30, 60, 80 and is therewith minimized. The microturbines 30, 60, 80 convert the lost energy which is otherwise output to the environment into electrical energy, which can be stored in an accumulator 40. It is conceivable for this reason to save on the generator in the motor vehicle 1 and to generate the required electrical energy with the aid of at least one microturbine 30, 60, 80. This technical solution reduces on the one hand the costs for the motor vehicle and on the other hand the weight of the motor vehicle 1, which in turn has a positive influence on the fuel consumption itself.

The invention is explained below in the example of the common rail injection system 20. It was already mentioned above, that the fuel in the return line to the tank is decompressed from the system pressure of the common rail injection system to the pressure in the return line. In this way, high flow speeds of the fuel appear in the return line, which previously remained unused in terms of energy. If a microturbine 30 operating according to the generator principle is integrated into the return line, this is powered by the fuel flowing into the tank. This movement is converted into electrical energy by the microturbine 30 which can be stored in an accumulator 40.

According to one embodiment, the microturbine 30 is monitored with a controller. This controller switches the microturbine 30 on and off and conveys the electrical energy generated by the microturbine 30 to the accumulator 40 or to other components in the motor vehicle 1. With the aid of this machine-aided embodiment, the energy released by the pressure drop is not converted into heat in the common rail system, but is instead used to power the microturbine 30.

The effect of this microturbine 30 is thus the same as with a hydropower plant. The pressure drop of the fuel causes high flow speeds of the same to appear in a narrow cross-section. The aerodynamic energy then powers the microturbine 30, which is used to generate current. It is conceivable on this basis for the microturbine 30 to replace the generator in the motor vehicle 1 in the case of an adequate performance.

As a result of the already afore-described dimensions in the microturbine 30, this can be directly installed on the throttle point of the pressure valve PCV. It is likewise conceivable to position the microturbine 30 at any throttle point. Only an adequate flow speed of the medium of the system needs to be present at this throttle point in order to power the microturbine 30. This is however always the case in the event of a decompression of a highly pressurized medium. It is thus likewise conceivable to use a microturbine 60 in conjunction with a pressurized air system and/or a microturbine 80 in conjunction with a hydraulic system 70 in the motor vehicle 1.

In order to generate the electrical energy in the motor vehicle, one or a plurality of microturbines 30, 60, 80 can thus be installed. In addition to these microturbines 30, 60, 80 powered by the systems 20, 50, 70, it is likewise conceivable to use microturbines which burn the fuel themselves and operate in a similar fashion to a gas turbine or an internal combustion engine. Microturbines of this type require little space, have a minimal weight in comparison to an accumulator and could replace the generator and/or the accumulator or result at least in a miniaturization of the accumulator 40.

The microturbines 30, 60, 80 are preferably activated, monitored and/or switched on and off with the aid of the already afore-described controller. It is thus possible according to one alternative to power at least one of the microturbines 30, 60, 80 permanently by means of one of the systems 20, 50, 70. It is likewise preferable to temporarily switch on and off one of the microturbines 30, 60, 80 so that the appropriate microturbine 30, 60, 80 is also only temporarily powered by the corresponding system 20, 50, 70. If energy is intentionally discharged from the high pressure injection system 20 and/or the hydraulic system 70 and/or the pressurized air system 50, in order to relieve the respective system 20, 50, 70, the corresponding microturbine can be intentionally switched on in order to convert the energy, which is to be discharged in order to relieve the system, into electrical energy. It is similarly conceivable with the above-described arrangement to temporarily switch off a microturbine 30, 60, 80 powered permanently by a system 20, 50, 70 in order in this way to reduce the load of the system 20, 50, 70 by the microturbine 30, 60, 80.

What is claimed is:

1. A device for generating electrical energy in a motor vehicle, comprising:
a) at least one microturbine with a controller, wherein
b) the at least one microturbine can be connected to an energy-conveying system of the motor vehicle, such that
c) the at least one microturbine can be powered by the energy-conveying system in order to provide electrical energy for systems of the motor vehicle.

2. The device according to claim 1, wherein the device comprises an accumulator, in which the electrical energy generated by the microturbines can be stored.

3. The device according to claim 1, wherein the controller of which the microturbine can be switched on and off, so that the energy which can be discharged for unloading the energy-conveying system can be used by the microturbine.

4. A motor vehicle, comprising:
a) at least one microturbine, with which electrical energy can be generated.
b) an energy-conveying system, with which energy can be transmitted to other components of the motor vehicle and can be connected to the microturbine so that the microturbine can be powered by the subsystem, and
c) an accumulator, in which the electrical energy generated by the microturbine can be stored,

5. The motor vehicle according to claim 4, wherein the motor vehicle does not include a generator.

6. The motor vehicle according to claim 4, wherein the at least one microturbine of the motor vehicle can be powered by fuel.

7. The motor vehicle according to claim 4, wherein the energy-conveying system of the motor vehicle is at least one of a high pressure injection system, a hydraulic system and a pressurized air system of the motor vehicle.

8. The motor vehicle according to claim 7, wherein the at least one microturbine of the motor vehicle can be coupled to the high pressure injection system and/or the hydraulic system and/or the pressurized air system such that energy discharged in order to relieve the system can be converted into electrical energy by the microturbine.

9. The device according to claim 1, wherein the energy-conveying system is at least one of a high pressure injection system, a hydraulic system and a pressurized air system.

10. The device according to claim 3, wherein the energy-conveying system is at least one of a high pressure injection system, a hydraulic system and a pressurized air system.

11. The device according to claim 10, wherein the controller of which the microturbine can be switched on and off, so that the energy which can be discharged for unloading at least one of the high pressure injection system, of the hydraulic system and of the pressurized air system can be used by the microturbine.

12. The device according to claim 1, wherein the energy-conveying system can be unloaded by switching the microturbine off.

13. The device according to claim 10, wherein at least one of the high pressure injection system, the hydraulic system and the pressurized air system can be unloaded by switching the microturbine off.

14. A method for generating electrical energy in a motor vehicle, which has the following features:
connecting at least one microturbine to an energy-conveying system such that the at least one microturbine can be powered by the energy-conveying system in order to provide electrical energy for systems of the motor vehicle.

15. The method according to claim 14, wherein the energy-conveying system is at least one of a high pressure injection system, a hydraulic system and a pressurized air system.

16. The method as claimed in claim 14, further comprising the step of storing the electrical energy generated by the microturbines in an accumulator.

17. The method as claimed in claim 14, further comprising the step of switching the microturbine on and off, so that the energy which can be discharged for unloading the energy-conveying system can be used by the microturbine.

18. The method as claimed in claim 14, further comprising the step of switching the microturbine off to unload the energy-conveying system.
